(19) United States
(12) Patent Application Publication
(10) Pub. No.: US 2012/0250086 A1
(43) Pub. Date: Oct. 4, 2012

(54) IMAGE FORMING SYSTEM

(76) Inventor: Kenichiro IMAYOSHI, Osaka (JP)

(21) Appl. No.: 13/423,451

(22) Filed: Mar. 19, 2012

(30) Foreign Application Priority Data
Apr. 1, 2011 (JP) 2011-081915(P)

(51) Int. Cl. G06K 15/02

(52) U.S. Cl. 358/1.15

(57) ABSTRACT

An image forming system includes an image forming apparatus and a server connected to a network. The image forming apparatus shows a first operation screen image for setting basic information related to image formation on an operation unit. The first operation screen image includes an activation area causing an external processing device to execute a process for specifying information for generating a second operation area for obtaining additional information related to image formation in the first operation screen image. The image forming apparatus forms an image in accordance with the basic information and the additional information. Thus, the additional information can be uniformly managed, and the user can form an image with desired information added, without the necessity of registering the additional information beforehand in the image forming apparatus.

### CROSS-REFERENCE TO RELATED APPLICATION

This nonprovisional application claims priority under 35 U.S.C. §119(a) on Patent Application No. 2011-081915 filed in Japan on Apr. 1, 2011, the entire contents of which are hereby incorporated by reference.

### BACKGROUND OF THE INVENTION

1. Field of the Invention

The present invention relates to an image forming system including an image forming apparatus and a server computer transmitting additional information for image formation in response to a request from the image forming apparatus.

2. Description of the Background Art

An image forming apparatus forming an image on a sheet of recording paper based on digital data of a document read by a scanner or digital data received through a communication line has come to be widely used. The image forming apparatus encompasses copy machines, facsimile machines and multifunction peripherals (MFPs). An MFP has a plurality of functions including copying, printing, sending facsimile (hereinafter facsimile will also be denoted as FAX) and scanning.

An image forming apparatus has a function of executing electronic image processing on the image data before forming an image on a sheet of recording paper. As one image processing function, a technique (image synthesis) of superposing an image representing additional information such as date, a logo mark, or an indication of “CONFIDENTIAL” or “IMPORTANT” on the original document image has been known. An image forming apparatus forming an image bearing the additional image on a sheet of recording paper has been commercially available.

By way of example, Japanese Patent Laying-Open No. 62-139468 (hereinafter referred to as '468 Reference) discloses a digital recording apparatus recording (printing) an image formed by synthesizing a document image read by a scanner and character patterns transmitted from a computer or a word processor. In the digital recording apparatus, character code data edited, for example, by a word processor is stored in a page memory, and while an image document is being read by a scanner, the code data on the page memory is converted to pixel data of corresponding character pattern, in synchronization with the timing of image scanning. The character pattern data and the image data are synchronized and synthesized (performing OR or Exclusive OR operation), and the result is recorded (printed) as an image. As additional information, time, date and ruled lines are disclosed.

Further, Japanese Patent Laying-Open No. 2003-274133 (hereinafter referred to as '133 Reference) discloses an image forming apparatus such as a digital copy machine, a printer or a facsimile machine, including means for printing, on a document image, other images including a page number, a stamp and date stored in advance in a page memory. In the image forming apparatus, if other image or images of a color designated by the user exist in the page memory, the image forming apparatus synthesizes the other image or images with the document image directly. If other image or images of the designated color do not exist in the page memory, the image forming apparatus generates the other image of the designated color and synthesizes the generated image with the document image.

In the image forming apparatuses disclosed in '468 and '133 References, however, the additional information to be used must be registered in advance in the image forming apparatuses themselves. Registering the additional information in the image forming apparatus itself is particularly troublesome where a plurality of image forming apparatuses are used, for example, at a company. Therefore, though attaching additional information to a document image is a function provided in the image forming apparatus, this function has not been effectively utilized.

### SUMMARY OF THE INVENTION

In view of the problem described above, it is desirable to provide an image forming system which is capable of uniform management of additional information, eliminates necessity of registering the additional information in advance in the image forming apparatus and allows the user to add desired information at the time of image formation.

The present invention provides an image forming system including an image forming apparatus and an external processing device. The image forming apparatus includes a first operation section for setting basic information related to image formation by the image forming apparatus; the first operation section includes an activating section causing the external processing device to execute a process for specifying information for generating a second operation section to obtain additional information related to image formation by the image forming apparatus; and the image forming apparatus forms an image in accordance with the basic information and the additional information.

Preferably, the image forming apparatus obtains the information specified by the external processing device from the external device, and generates the second operation section using the obtained information.

More preferably, the second operation section causes the external processing device to execute a prescribed process; and the image forming apparatus obtains information of result of execution of the prescribed process by the external processing device, and uses the obtained information as the additional information.

More preferably, the information of result of execution of the prescribed process is image information.

Preferably, the external processing device includes a timer; and the prescribed process executed by the external processing device is a process by the external processing device of specifying year, month and date from the timer and of generating image data representing the year, month and date.

More preferably, the first operation section further includes an input unit for inputting information; the image forming apparatus transmits, when the second operation section obtains the additional information, input information input through the input unit to the external processing device; the external processing device generates image information to be provided to the image forming apparatus in accordance with the received input information, and transmits the generated image information to the image forming apparatus; and the image forming apparatus uses the received the image information as the additional information for forming an image.

More preferably, the image forming apparatus further includes a storage unit for receiving and storing image information transmitted from the external processing device; and when an instruction to obtain the additional information is issued by the second operation section, the image information stored in the storage unit is used as the additional information.

According to the present invention, when an image is formed by the image forming apparatus, an application in the server (external processing device) is activated from the image forming apparatus, a screen image (second operation section) for obtaining a stamp image (additional information) to be added to the formed image is formed using results of execution of the application obtained from the server, and using this screen image, the stamp image is obtained from the external processing device. Therefore, it is unnecessary to register any stamp image in the image forming apparatus, and when forming an image, the user can add a desired stamp image to the image being formed.

Since the stamp image or images added at the time of image formation by the image forming apparatus are managed uniformly by the server, it is possible to realize the function of adding stamp images in a plurality of image forming apparatuses in an efficient manner.

The server provides the stamp image data and the conditions for forming the stamp images with the image forming apparatus and, thus, image formation by the image forming apparatus become easier.

In addition to the stamp images registered in advance, the server generates an image including characters such as date of formation and page number in response to a request from the image forming apparatus, and provides it as a stamp image with the image forming apparatus. Therefore, the user has high degree of freedom in designating the stamp image or images.

As the image forming apparatus stores the stamp image data transmitted from the server, it becomes unnecessary to request for the stamp image when the user instructs to add the stamp image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an appearance of the image forming apparatus used in the image forming system in accordance with an embodiment of the present invention.

FIG. 2 is a block diagram showing a configuration of the image forming system in accordance with the embodiment of the present invention.

FIG. 3 is a flowchart representing a control structure of a program for attaching an additional image to the document image, in the image forming system in accordance with the embodiment of the present invention.

FIGS. 4 and 5 show screen images displayed on an operation unit of the image forming apparatus.

FIG. 6 shows data managed by the server.

FIG. 7 shows a synthesized image provided from the server to the image forming apparatus.

FIGS. 8 and 9 show screen images displayed on the operation unit of the image forming apparatus.

FIG. 10 shows an image with the stamp image added.

### DESCRIPTION OF THE PREFERRED EMBODIMENTS

In the following embodiments, the same components are denoted by the same reference characters. Their names and functions are also the same. Therefore, detailed description thereof will not be repeated.

The image forming system in accordance with an embodiment of the present invention includes an image forming apparatus and a server computer (hereinafter simply referred to as a “server”) connected to each other by a network. The image forming apparatus is a digital multifunction peripheral having a plurality of functions such as scanner function, copy function, facsimile function and printer function.

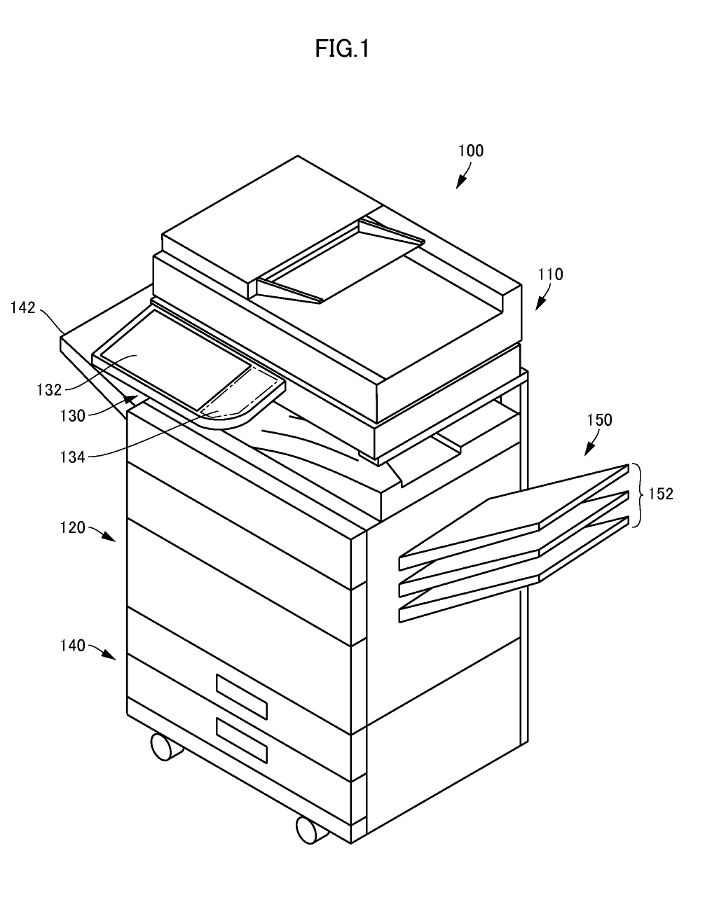

Referring to FIG. 1, an image forming apparatus 100 includes a document reading unit 110, an image forming unit 120, an operation unit 130, a paper feed unit 140, a manual feed tray 142, and a paper discharge unit 150. Operation unit 130 includes a touch-panel display 132 and an operation key portion 134. Touch-panel display 132 includes a display panel formed, for example, of a liquid crystal panel, and a touch-panel placed on the display panel, detecting a touched position. On operation key portion 134, several function keys, not shown, are arranged. Ten-keys may be arranged on operation key portion 134.

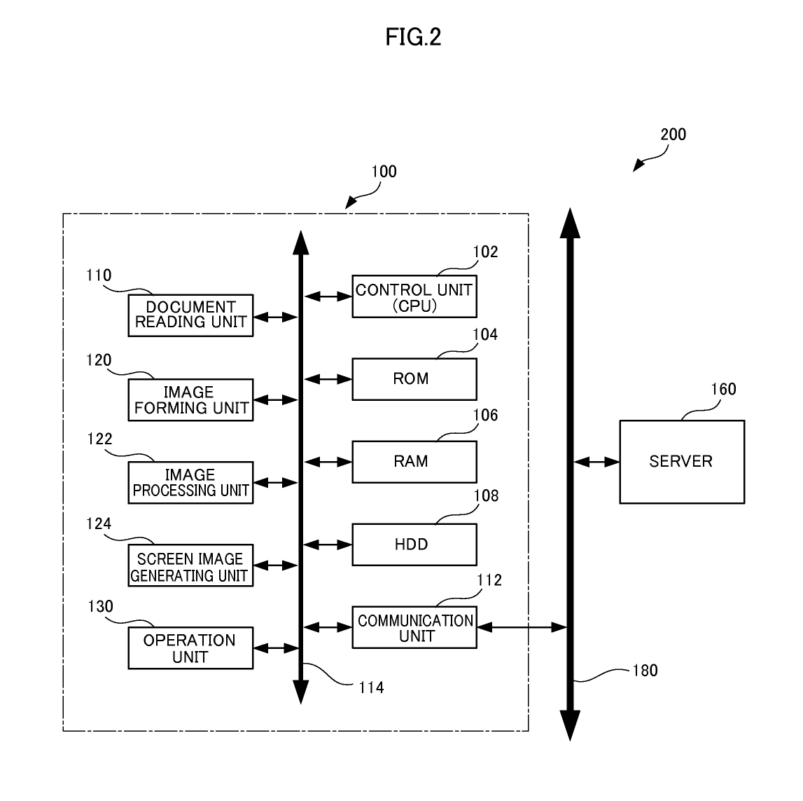

Referring to FIG. 2, an image forming system 200 in accordance with the present embodiment includes image forming apparatus 100, a server 160, and a network 180 to which these are connected. Though a plurality of image forming apparatuses 100 may be included in image forming system 200, only one is shown as a representative in FIG. 2.

Image forming apparatus 100 includes a control unit (hereinafter referred to as a CPU: Central Processing Unit) 102 for overall control of image forming apparatus 100, an ROM (Read Only Memory) 104, an RAM (Random Access Memory) 106, and an HDD (Hard Disk Drive) 108. ROM 104 is a non-volatile storage that retains data even when power is shut off. ROM 104 stores programs and data necessary for controlling operations of image forming apparatus 100. RAM 106 is a volatile storage. HDD 108 is a non-volatile storage.

Image forming apparatus 100 further includes an image processing unit 122, a screen image generating unit 124, a communication unit 112 and a bus 114. CPU 102, ROM 104, RAM 106, HDD 108, communication unit 112, document reading unit 110, image forming unit 120, image processing unit 122, screen image generating unit 124, and operation unit 130 are connected to bus 114. Exchange of data (including control information) between each of these components is done through bus 114. CPU 102 reads a program, from ROM 104 to RAM 106 through bus 114, and executes the program using a part of RAM 106 as a work area. Specifically, CPU 102 controls various units and components forming image forming apparatus 100 in accordance with the programs stored in ROM 104 and realizes various functions of image forming apparatus 100.

Communication unit 112 is connected to an external network 180. Communication unit 112 is provided, for example, with MC (Network Interface Card), as an interface for image forming apparatus 100 to communicate with an external device through network 180. Further, communication unit 112 is also connected to an external telephone line (not shown). Communication unit 112 is provided with a FAX modem as an interface for image forming apparatus 100 to execute FAX communication with an external device through the telephone line.

Document reading unit 110 includes a CCD (Charge Coupled Device) for reading an image, and a document detection sensor for detecting a document set on a platen and an automatic document feeder (ADF). By these components, document reading unit 110 reads the documents and forms image data. The image data is temporarily stored in an image memory (not shown). Image processing unit 122 executes various image processing operations on the read image data. Image forming unit 120 prints the image data on a sheet of recording paper. The image data is stored in HDD 108 as needed.

Paper feed unit 140 holds sheets of recording paper for forming images. Manual feed tray 142 is for manually feeding the sheets of recording paper.

Operation unit 130 receives inputs including user instructions to image forming apparatus 100. An image displayed on touch-panel display 132 is generated by screen image generating unit 124. By screen images displayed on touch-panel display 132, a user confirms a state of image forming apparatus 100 and confirms status of job processing. It is possible for the user to set functions and instruct operations of image forming apparatus 100 by selecting keys displayed on touch-panel display 132 on the touch-panel superposed on the display panel (by touching corresponding portions on the touch-panel). Whether or not a displayed key is touched on touch-panel display 132 may be determined using a known technique. By way of example, correspondence relation between two-dimensional coordinates of the touch-panel and two-dimensional coordinates of the display panel is determined beforehand, and whether or not a touched position on the touch-panel is within a region of a character, figure or the like displayed on the display panel may be determined.

CPU 102 monitors user operations on touch-panel display 132 and input keys provided on operation unit 130, and displays, on touch-panel display 132, any information to be notified to the user, such as information related to the state of image forming apparatus 100.

Server 160 includes a CPU, an RAM, an ROM, an HDD and an NIC, similar to a general purpose computer. As will be described later, server 160 manages in HDD the data to be transmitted to image forming apparatus 100 in response to a request from image forming apparatus 100.

In the following, various modes for executing the functions (copy function, printer function, scanner function and facsimile function) of image forming apparatus 100 will be briefly described.

(Copy Mode)

When image forming apparatus 100 is used as a copy machine, image data of a document read by document reading unit 110 is output as a copy from image forming unit 120.

By the CCD provided in document reading unit 110, an image of a document set at a reading position can electronically be read. The read image data is completed as output data (print data) on the image memory, and then stored in HDD 108. If there is a plurality of documents, the reading operation and the storage operation are repeated. Thereafter, based on a processing mode instructed from operation unit 130, image data stored in HDD 108 is successively read at appropriate timing and sent to the image memory. Then, the image data is transferred to image forming unit 120, timed with image formation at image forming unit 120.

When a plurality of pages of read image data are to be printed, similarly, the image data stored page by page in HDD 108 is transferred as output data from HDD 108 to the image memory and transferred to image forming unit 120 timed with image formation, repeatedly by the number of pages to be output.

At feeding unit 140, a sheet of recording paper is drawn by a pick-up roller. The drawn recording paper is conveyed to image forming unit 120 by means of a plurality of conveyer rollers. In image forming unit 120, a charged photoreceptor drum is exposed in accordance with the input image data, so that an electrostatic latent image corresponding to the image data is formed on a surface of the photoreceptor drum. Toner is applied to the electrostatic latent image portion oh the photoreceptor drum, and the image formed by the applied toner is transferred, by means of a transfer belt, to the conveyed sheet of recording paper. Thereafter, the recording paper is heated and pressed (whereby the image is fixed on the recording paper), and discharged to discharge tray 152.

(Printer Mode)

When image forming apparatus 100 is used as a printer, the image data received through communication unit 112 is output from image forming unit 120 through the image memory or the like.

Communication unit 112 receives image data from a terminal (not shown) such as a computer connected to network 180. The received image data is sent page by page as output image data to the image memory, and then stored in HDD 108. Then the image data is again sent from HDD 108 to the image memory, transferred to image forming unit 120 in the similar manner as in the copy mode described above, and the image is formed.

(Scanner Mode)

When image forming apparatus 100 is used, for example, as a network scanner, document image data read by document reading unit 110 is transmitted to a terminal such as a computer, from communication unit 112 through network 180. Here again, by the CCD provided in document reading unit 110, the document is read electronically. The read image data of the document is completed as output data on the image memory, and stored in HDD 108. The image data is again sent from HDD 108 to the image memory, and after a communication with a designated transmission destination is established through operation unit 130, transmitted to the designated transmission destination from communication unit 112.

(Facsimile Mode)

Image forming apparatus 100 is capable of FAX transmission/reception to and from external facsimile machines through the FAX modem and the telephone line.

When image forming apparatus 100 is used as a facsimile machine, data received by FAX from a facsimile machine may be formed as image data in the image memory and stored in HDD 108 or printed by image forming unit 120 in the similar manner as described above. Further, image forming apparatus 100 may read image data from HDD 108, convert the data to a data format for FAX communication and transmit the data to an external facsimile machine through the FAX modem and the telephone line.

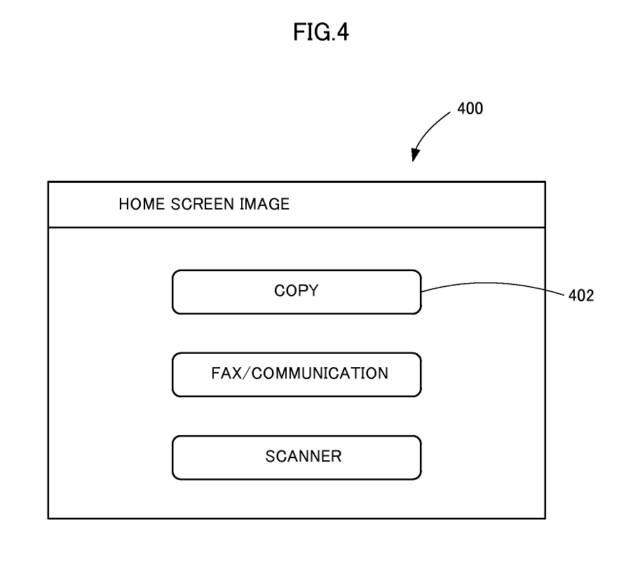

In the following, a control structure of a program executed by CPU 102 of image forming apparatus 100 when image forming apparatus 100 and server 160 cooperate to form an image in image forming system 200 will be described. Specifically, formation of an image prepared by superposing a partial image (digital data) provided from server 160 on an image (digital data) obtained by image forming apparatus 100 reading an original document, on a sheet of recording paper will be described. By way of example, assume that CPU 102 is displaying a home screen image 400 shown in FIG. 4 on touch-panel display 132, while the user sets a document on document reading unit 110 and touches a copy key 402 among the keys displayed on home screen image 400 to select the copy mode.

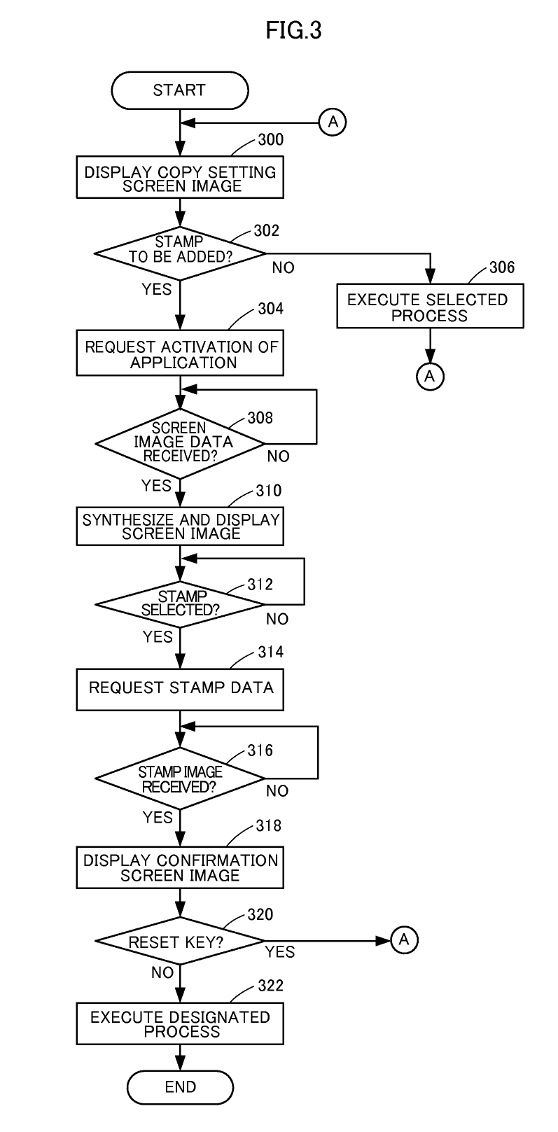

Referring to FIG. 3, at step 300, CPU 102 displays a basic operation screen image 500 of the copy mode in touch-panel display 132, to wait for a key operation by the user. If CPU 102 detects touching of any key, the control proceeds to step 302.

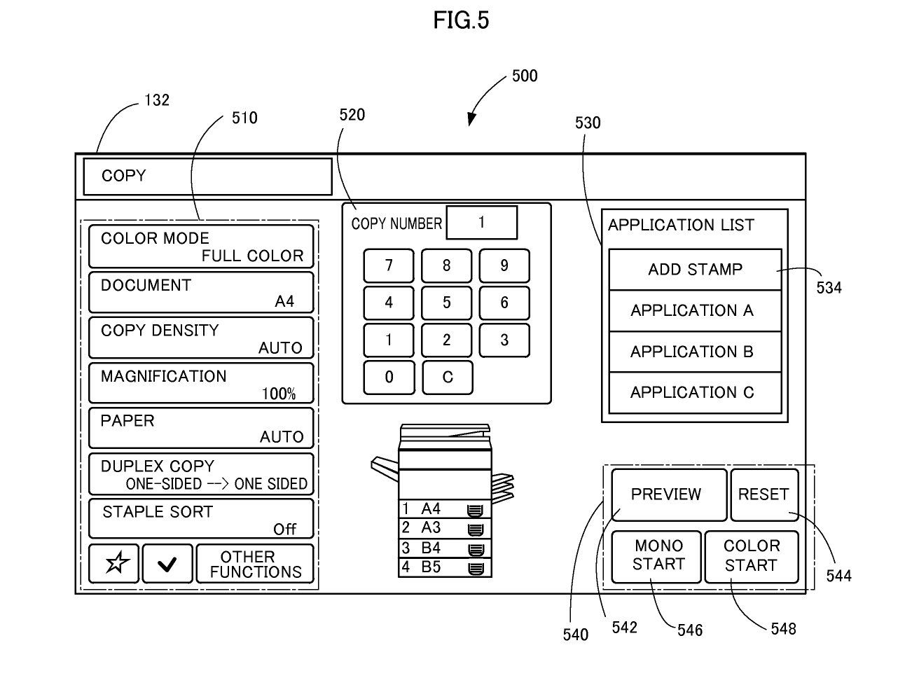

At an upper left corner of screen image 500, there is an indication of copy mode. Screen image 500 is for allowing setting related to the copy mode and to instruct execution of copying. Screen image 500 is a screen image first appears when the copy mode is selected. Screen image 500 includes a function setting area 510, a ten-key area 520, an application activation area 530 and a task trigger area 540. On function setting area 510, a plurality of keys (hereinafter also referred to as function setting keys) for setting various functions of image forming apparatus 100 are displayed. In function setting area 510 of FIG. 5, only some of the function setting keys are displayed. Function setting keys not displayed appear when “other function” key is pressed. Ten-key area 520 includes ten keys (numerical keys “0” to “9” and clear key “C”) and a display area for displaying the number of copies. The number of copies is entered by the ten keys. In FIG. 5, the number of copies is set to 1.

In application activation area 530, keys for selecting an application to be executed by server 160 are displayed. Here, as a specific example of the keys, a stamp addition key 534 is shown, and other keys are displayed as applications A to C. As will be described later, when a key in application activation area 530 is touched, server 160 activates the corresponding application.

Task trigger area 540 is an area on which keys serving as triggers for image forming apparatus 100 to start certain processes are displayed. Specifically, a mono start key 546, a color start key 548, a preview key 542 and a reset key 544 are displayed. Mono start key 546 is to start monochrome copying. Color start key 548 is to start color copying. Preview key 542 is to start a process for once reading a document and displaying a preview image in a prescribed format on touch-panel display 132. Reset key 544 is for clearing all settings.

At step 302, CPU 102 determines whether or not the touched key is stamp addition key 534. If it is determined to be stamp addition key 534, the control proceeds to step 304. If it is determined not to be stamp addition key 534, the control proceeds to step 306, at which a process corresponding to the touched key is executed, and then, the control returns to step 300. If reset key 544 is touched while screen image 500 is displayed, home screen image 400 is resumed (specifically, screen image 500 is erased and home screen image 400 is displayed).

At step 304, CPU 102 transmits data requesting activation of the application corresponding to the selected key, that is, activation of the stamp addition application, to server 160 through communication unit 112 and network 180.

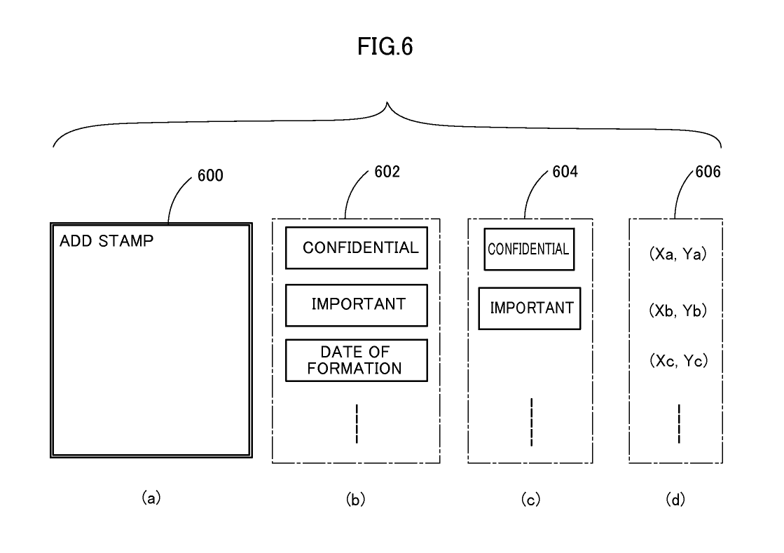

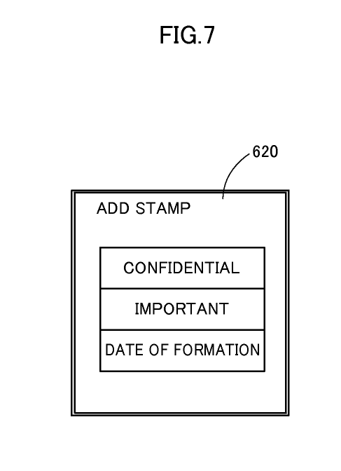

Receiving the data requesting activation of an application from image forming apparatus 100, server 160 executes the corresponding application. Here, server 160 executes the application of adding a stamp. Specifically, from the data stored in HDD of server 160 such as shown in (a) to (d) of FIG. 6, server 160 selects a base image 600 and a plurality of stamp key images 602 representing types of stamps. From the read images, server 160 forms a synthesized image 620 shown in FIG. 7, and transmits the generated synthesized image 620 to image forming apparatus 100. FIG. 6 shows types of stamps including “CONFIDENTIAL”, “IMPORTANT” and “DATE OF FORMATION.” As to “CONFIDENTIAL” and “IMPORTANT,” stamp images 604 registered beforehand are directly used as stamps. As to the “DATE OF FORMATION,” it means that the year, month and date of image formation are to be added as a stamp, and server 160″generates a corresponding stamp image, as will be described later.

The plurality of stamp key images 602 are displayed as keys on touch-panel display 132 of image forming apparatus 100. Therefore, in synthesized image 620, position information for specifying an area for each of the plurality of stamp key images 602 is necessary. Conditions for this purpose may be determined in advance, and necessary pieces of information may be stored in HDD 108 of image forming apparatus 100. By way of example, the plurality of stamp key images 602 are adapted to have the same size (number of pixels, in widthwise and lengthwise directions) regardless of the type of stamp key images. Then, by designating position coordinates of a representative point (for example, the upper left point) of the stamp key image arranged at the highest position on the synthesized image 620, each range of second and the following stamp key images can be identified.

At step 308, CPU 102 determines whether or not image data has been received from server 160. CPU 102 repeats the process of step 308 until the image data is received. If it is determined that the image data has been received, the control proceeds to step 310. Here, CPU 102 receives synthesized image 620 shown in FIG. 7.

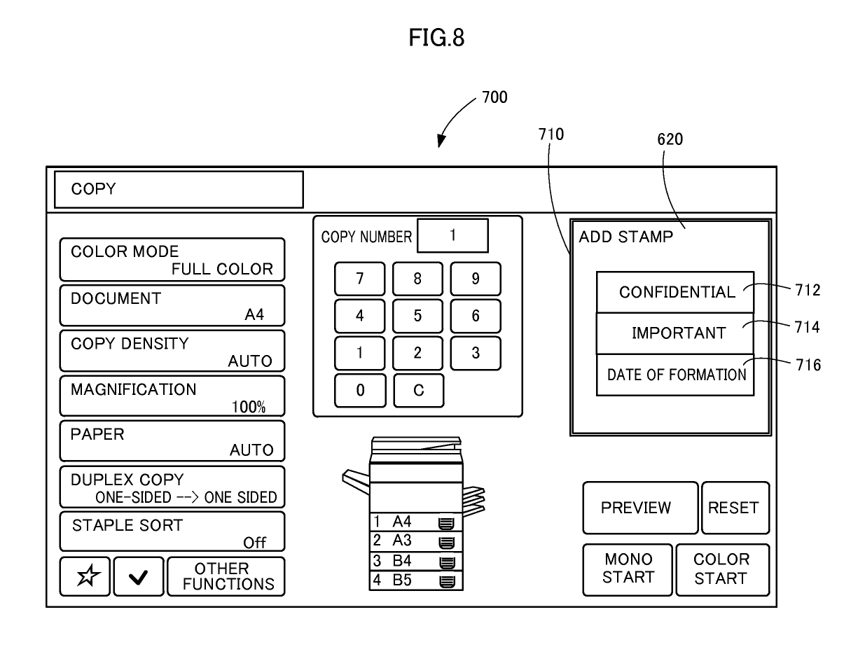

At step 310, CPU 102 generates image data including the image data received from server 160 as a part and displays the generated image on operation unit 130, and waits for a key operation by the user. If touching of any key is detected by CPU 102, the control proceeds to step 312. Specifically, a screen image 700 shown in FIG. 8 appears on touch-panel display 132. On screen image 700, in place of application activation area 530 of screen image 500, synthesized image 620 received from server 160 is displayed on a plug-in area (embedded area) 710. Plug-in area 710 is an area for displaying information obtained from an application of server 160.

At step 312, CPU 102 determines whether or not a stamp is selected. CPU 102 repeats the process of step 312 until a stamp is selected. Specifically, CPU 102 finds the position coordinates of the touched position on touch-panel display 132, and determines whether the position is within the area of any of CONFIDENTIAL key 712, IMPORTANT key 714 and DATE OF FORMATION key 716. The information specifying the positions of the areas of CONFIDENTIAL key 712, IMPORTANT key 714 and DATE OF FORMATION key 716 is stored beforehand in HDD 108, as described above. If it is determined that a stamp is selected, the control proceeds to step 314.

At step 314, CPU 102 requests server 160 for the stamp data corresponding to the touched key. Specifically, CPU 102 transmits information specifying the stamp (stamp specifying information) and the request data to server 160. The method of specifying a stamp corresponding to the touched key may be selected appropriately, and any method determined in advance with server 160 may be used. By way of example, as the stamp specifying information, a numerical value indicating the order of touched key (for example, order starting from the top), or representative coordinates of the touched key (for example, position coordinates of an upper left corner of the key area) may be used.

Receiving the data-requesting the stamp and the information specifying the stamp from image forming apparatus 100, server 160 transmits the corresponding stamp image and prescribed position information to image forming apparatus 100. Specifically, server 160 transmits, in accordance with the stamp specifying information, corresponding image data among the plurality of stamp images 604 and the corresponding coordinate data among the pieces of additional position information 606. The additional position information 606 is information for specifying the position where the stamp image is to be formed on a sheet of recording paper. By way of example, coordinate data such as (Xa, Ya) and (Xb, Yb) are position coordinates with the upper left corner of recording paper used as a reference. Here, it is assumed that the type of stamp and additional position information are in one-to-one correspondence relation. Therefore, when CONFIDENTIAL key 712, IMPORTANT key 714 or DATE OF FORMATION key 716, is touched, coordinate data (Xa, Ya), (Xb, Yb) or (Xc, Ye) is transmitted, respectively.

If DATE OF FORMATION key 716 is touched and the corresponding stamp specifying information is received by server 160, server 160 specifies the current year, month and date from an internal timer, and generates image data including characters representing the year, month and data (such as 2011.3.24) as a stamp image. Server 160 transmits the generated stamp image and the coordinate data (Xc, Ye) to image forming apparatus 100.

At step 316, CPU 102 determines whether or not the stamp image and the additional position information are received from server 160. CPU 102 repeats the process of step 316 until these data are received. If it is determined that the data are received, the control proceeds to step 318.

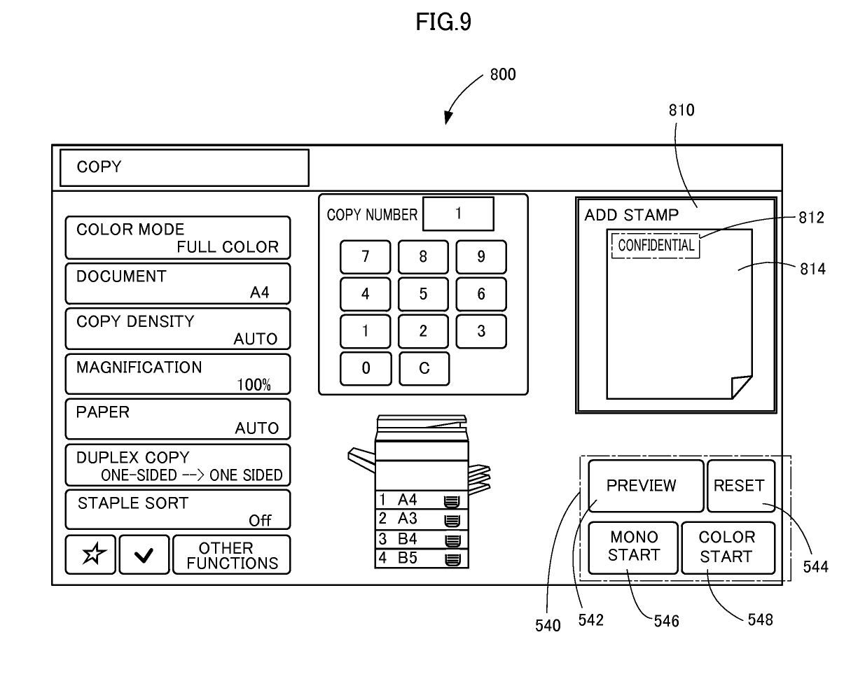

At step 318, CPU 102 generates an image indicating a state in which the stamp is added on the recording paper using the stamp image data and the additional position information received from server 160 at step 316, and displays the generated image on operation unit 130 (see FIG. 9). In this state, CPU 102 waits for a key operation by the user. CPU 102 repeats step 316 until any key in task trigger area 540 is touched. In a screen image 800 of FIG. 9, a confirmation screen image 810 is displayed. Confirmation screen image 810 is prepared by superposing an image 814 representing the recording paper on synthesized image 620, and superposing a reduced image 812 of the stamp image on image 814. CPU 102 reads data of image 814 representing the recording paper from HDD 108, and at a position of the image specified by the additional position information, superposes (synthesizes) reduced image 812 obtained by reducing the stamp image received from server 160. It can be seen from FIG. 9 that a stamp “CONFIDENTIAL” is printed at an upper left portion of the recording paper. Here, image 814 used for confirmation screen image 810 should preferably be an image prepared in consideration of the copy conditions set by keys in function setting area 510, that is, the size of recording paper and the printing direction. By way of example, a plurality of different images 814 representing sheets of recording paper (for example, of A4, B5 and B4) may be recorded in HDD 108, and an appropriate image may be selected and used in accordance with the size of recording paper and the printing direction.

At step 320, CPU 102 determines whether or not reset key 544 is touched. If reset key 544 is touched, all settings related to the copy mode are reset, and the control returns to step 300. If any key in task trigger area 540 other than reset key 544 is touched, the control proceeds to step 322.

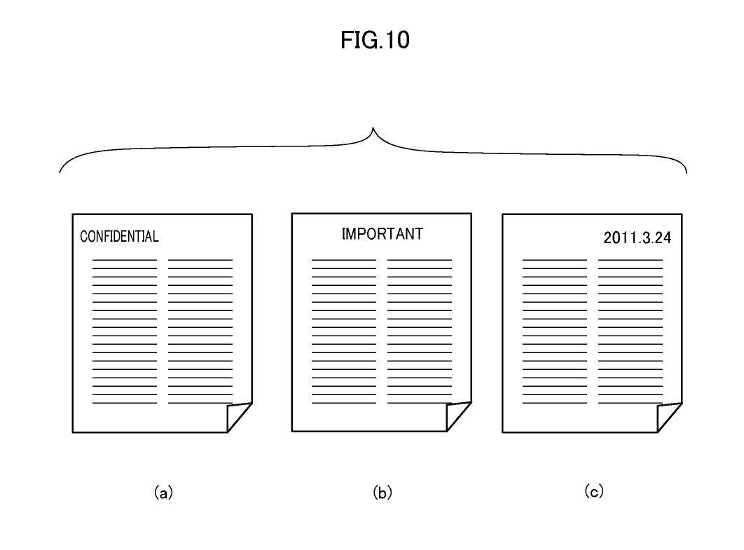

At step 322, CPU 102 executes a process corresponding to the touched key. If mono start key 546 or color start key 548 is touched, CPU 102 executes the copying operation. Specifically, in accordance with the set copy conditions, CPU 102 reads the document set at document reading unit 110, generates image data, superposes (synthesizes) the stamp image at a position designated by the additional position information on the image data and thereby generates image data for printing, and using the image data for printing, forms an image on a sheet of recording paper. In this manner, copies of documents having stamps added as shown, for example, in (a) to (c) of FIG. 10 are formed. The image (a) on the left side of FIG. 10 represents a copy with the stamp “CONFIDENTIAL” added at the upper left portion. The central image (b) of FIG. 10 represents a copy with the stamp “IMPORTANT” added at an upper central end, and the image (c) on the right end represents a copy of a document having “2011.3.24” representing the “DATE OF FORMATION” added at an upper right portion.

If preview key 542 is touched, CPU 102 once reads the document and displays a preview. If mono start key 546 or color start key 548 is touched thereafter, CPU 102 executes the copying operation. As described above, when the user makes a copy of a document using image forming apparatus 100, it is possible for image forming apparatus 100 to display types of stamps (stamp key images) on touch-panel display 132 to allow user selection, and to generate a copy of the document with the stamp selected by the user added, even if stamp images are not stored therein. Since the stamp images and the stamp key images are uniformly managed by server 160, these can be shared by a plurality of image forming apparatuses connected to network 180.

The stamp images are not limited to those described above. Stamp images of characters other than “CONFIDENTIAL” and “IMPORTANT” and stamp images not of characters may be used. The stamp image may include an image of a frame to be superposed on the edge of document image.

A page number may be added to the document image. By way of example, image forming apparatus 100 may count the number every time a document is scanned, and transmit the count value to server 160. Server 160 generates a stamp image including the received count value as a page number, and transmits it and the additional position information, to image forming apparatus 100. Image forming apparatus 100 can superpose the stamp image of the received page number on the position specified by the additional position information of the image data obtained by immediately preceding scanning. Thus, it becomes possible for the user to obtain copies having continuous page numbers added, of a plurality of documents read continuously. If image forming apparatus 100 changes the timing of transmitting the count value to the server during reading of the plurality of documents, it becomes possible to add page numbers to only some of the copies of continuously read document. By way of example, if the count value is transmitted only when the document is read for the first time, it becomes possible to add a page number only to the first page of the copy of document including a plurality of pages. If the count value is transmitted at every prescribed number of pages (for example, at every five pages or ten pages), it becomes possible to add a page number at every prescribed pages, of the copy of document including a plurality of pages. Image forming apparatus 100 may receive an input of characters through operation unit 130 and transmit the input characters to server 160, and server 160 may form an image including the input characters as a stamp image. By way of example, assume that an estimate is to be printed. On plug-in area 710 of screen image 700, an “ESTIMATE” key is provided, and if this key is touched, a screen image allowing input of an address is displayed on touch-panel display 132. If an address (for example, “Yamada”) is input, image forming apparatus transmits the address information (for example, character codes) to server 160, and server 160 generates a stamp image including the address (for example, an image including “Recommended Plan for Mr. Yamada”) and transmits the image to image forming apparatus 100. Thus, image forming apparatus 100 can form an estimate including the characters “Recommended Plan for Mr. Yamada”. The input characters may be the date of formation.

Though an example in which the position on the document where the stamp is to be added is determined in advance for each stamp image has been described, it is not limiting. The position on the document where the stamp is to be added may be designated using operation unit 130 of image forming apparatus 100. By way of example, a key or keys for designating the position of stamp image may be provided on screen image 800. Specifically, keys for selecting upper left, upper central end, upper right, lower left, lower central end and lower right portions may be provided. Alternatively, it may be possible to allow the user to enter position coordinates of a representative point of a stamp image through ten keys.

Though an example in which server 160 generates synthesized image 620 including stamp key images for selecting a stamp and transmits the same to image forming apparatus 100 has been described, the example is limiting. For instance, a base image 600 and a plurality of stamp key images 602 may be transmitted from server 160 to image forming apparatus 100, and image forming apparatus 100 may generate synthesized image 620. By such an approach, even if there are too many types of stamps to generate synthesized image 620 having all stamp key images 602 superposed on base image 600, it is possible on the side of image forming apparatus 100 to have the plurality of stamp key images displayed in a scrolled manner.

Though an example in which server 160 transmits the stamp key images, the stamp image and the like to image forming apparatus 100 when an application activation request for adding a stamp is received from image forming apparatus 100 has been described above, the example is not limiting. By way of example, the stamp key images, the stamp image and the like may be transmitted from server 160 to image forming apparatus 100 by periodical polling, and image forming apparatus 100 may store these for a prescribed time period. If information (stamp key image, stamp image or the like) related to addition of a stamp managed by server 160 is added, updated information may be transmitted from server 160 to image forming apparatus 100.

Though an example in which a stamp is added to image data of a document in the copy mode of the image forming apparatus has been described above, it is not limiting. The stamp may be similarly added in the printer mode, scanner mode, and the facsimile mode. Similar operation as in the copy mode is possible, by displaying the application activation area shown in FIG. 5, in the setting screen image of each mode.

The conditions related to addition of a stamp image are not limited to the additional position information described above. By way of example, the conditions may include stamp color, stamp luminance, transparency of the stamp (mixture ratio between the pixel values of document image and stamp image), stamp size and stamp direction.

Though an example in which an application executed by server 160 provides a stamp image to be added to the document image has been described above, the example is not limiting. An application executed by server 160 may provide information to be used for image processing executed by image forming apparatus 100 on the document image. By way of example, a mask pattern for trimming or filtering process, or pallet information for converting luminance or color may be provided from the server. In this case also, a key or keys for selecting information are displayed in the plug-in area, and information corresponding to the key touched by the user is transmitted from server 160 to image forming apparatus 100. Using the information received from server 160, image forming apparatus 100 executes image processing on the document image, and forms an image.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An image forming system comprising an image forming apparatus and an external processing device, wherein
said image forming apparatus includes a first operation section for setting basic information related to image formation by said image forming apparatus;
said first operation section includes an activating section causing said external processing device to execute a process for specifying information for generating a second operation section to obtain additional information related to image formation by said image forming apparatus; and
said image forming apparatus forms an image in accordance with said basic information and said additional information.

2. The image forming system according to claim 1, wherein said image forming apparatus obtains said information specified by said external processing device from said external device, and generates said second operation section using the obtained information.

3. The image forming system according to claim 1, wherein
said second operation section causes said external processing device to execute a prescribed process; and
said image forming apparatus obtains information of result of execution of said prescribed process by said external processing device, and uses the obtained information as said additional information.

4. The image forming system according to claim 3, wherein said information of result of execution of said prescribed process is image information.

5. The image forming system according to claim 3, wherein
said external processing device includes a timer; and
said prescribed process executed by said external processing device is a process by said external processing device of specifying year, month and date from said timer and of generating image data representing the year, month and date.

6. The image forming system according to claim 1, wherein
said first operation section further includes an input unit for inputting information;
said image forming apparatus transmits, when said second operation section obtains said additional information, input information input through said input unit to said external processing device;
said external processing device generates image information to be provided to said image forming apparatus in accordance with said received input information, and transmits said generated image information to said image forming apparatus; and
said image forming apparatus uses the received said image information as said additional information for forming an image.

7. The image forming system according to claim 1, wherein
said image forming apparatus further includes
a storage unit for receiving and storing image information transmitted from said external processing device; and
when an instruction to obtain said additional information is issued by said second operation section, the image information stored in said storage unit is used as said additional information.
